(19) United States
(12) Patent Application Publication
(10) Pub. No.: US 2016/0183569 A1
(43) Pub. Date: Jun. 30, 2016

(54) LEGUME SNACKS AND PROCESS FOR MANUFACTURE

(71) Applicant: Nitza OREN, Kfar Vradim (IL)

(72) Inventor: Nitza OREN, Kfar Vradim (IL)

(21) Appl. No.: 14/908,083

(22) PCT Filed: Jul. 21, 2014
(86) PCT No.: PCT/IL2014/050659

§ 371 Date: Jan. 27, 2016

(30) Foreign Application Priority Data
Jul. 29, 2013 (IL) 227713

(51) Int. Cl. A23L 1/00

(52) U.S. Cl. CPC A23L 1/2005; A23V 2002/00

(57) ABSTRACT

A method of producing a legume snack, and a legume snack produced by said method.

### FIELD OF THE INVENTION

The invention relates to a process for preparing healthy, tasty and nutritious legume snacks, and to snacks produced thereby.

### BACKGROUND OF THE INVENTION

All publications mentioned throughout this application are fully incorporated herein by reference, including all references cited therein.

There is a growing awareness to healthy nutrition in view of different health issues such as obesity, high cholesterol, and high blood pressure. Therefore, food and beverage manufacturers are often required to produce healthy food products. Various studies have found that consumption of whole grains and/or legumes may help in: reducing the risk of heart disease by decreasing cholesterol levels, blood pressure and blood coagulation; reducing the risk of cancer; regulating blood glucose in diabetic individuals; and experiencing staying “fuller” for a longer period of time. Accordingly, the invention described herein provides a healthy legume snack.

Nowadays, the demand for natural products, without additives or preservatives, also increases. Legumes are rich in protein, folic acid, copper, iron and magnesium. Currently, legumes are added, at low levels, to various products, such as cakes; or different additives are used to improve the stability and taste of legume-based foods. Alternatively, legumes are fried or coated with tasty (and not healthy) coatings. Therefore, a need exists for a method of providing a legume snack that contains higher levels of legumes compared to traditional products, and lower levels of un-healthy ingredients.

Legumes are the edible seeds that grow in pods on annual plants, bushes, or vines of the leguminosae family. The seeds can be eaten fresh, sprouted, fried, dried and ground into flour, or even cooked. Legumes are a good source of protein and can be a healthy substitute for meat. Legumes are typically low in fat, contain no cholesterol, and are high in protein, calcium, folate, potassium, iron, Vitamin B, and magnesium. They also have phytochemicals, a group of compounds that may help to prevent chronic diseases, such as cardiovascular disease and cancer. In addition, legumes are an excellent source of fiber, and a diet high in fiber can reduce the risk of developing diabetes and help lower blood cholesterol levels, which in turn reduces the risk of heart disease. Moreover, foods made of legumes can help in digestion in cessation of constipation problems.

The most common legume types include black beans, black-eyed peas, chickpeas (garbanzo), fava or broad beans, lima beans, navy beans, peas, pinto beans, soy beans, hummus, lentils, white beans, mash and red kidney beans.

The present invention is thus directed toward satisfying the need for healthy and natural snack products. The method of the present invention as described herein provides for such legume snacks.

In addition to their above-mentioned nutritious advantages, legumes are also extremely advantageous for treating various health conditions and illnesses. For example, peas are rich in iron and beta carotene and are good for anemia; chickpeas are good against intestinal parasites and for disinfecting the urinary tract; lentils are rich in protein and are good for relieving the muscles and for blood circulation; red- and mang-beans are useful diuretics; adzuki beans help with kidneys bladder problems and is connected with increasing the human milk production for mothers after birth. Accordingly, snacks made of legumes posse many advantages, both dietary and healthy. JP 2009/171867 provides a method for producing soft-boiled beans, while maintaining their original deliciousness. KR 1020000034334 describes a method for preparing processed bean snack for children and elders, who evade eating beans. The method involves soaking the beans in water for 12 hours, boiling them for softening, drying the boiled beans, and soaking the dried beans in a sugared liquid.

It is therefore an object of the present invention to provide a method for producing legume snacks, which are tasty and healthy, and which are suitable for all ages and health-conditions, without adding artificial sweeteners thereto. In addition, the legume snacks of the invention can be modified based on the geographic location of the consumer, the consumer's favorite flavor(s), age and life style. Moreover, the legume snacks of the invention can be prepared to be suited for a variety of health conditions that require unique diets or nutrition regimens, e.g. with low sugar, low fat, low salt, low-carb, cholesterol-free and gluten-free. It is another object of the invention that the legume snacks are prepared in combination with cereals, optionally whole cereal, such as rice, wheat, oat-wheat, spelt, rye, millet, quinoa, amaranth, etc.

In another embodiment, the legume snacks of the invention might also comprise sweeteners, either artificial or natural, such as dates, silan, honey, carobs honey, etc.

It is another object of the invention to provide healthy and tasty legume snacks.

The above and other objects and advantages of invention will become apparent as the description proceeds.

### SUMMARY OF THE INVENTION

The present invention relates to a method of producing a legume snack, comprising the steps of:
a) washing the legumes to remove dirt, stones and bad legumes;
b) soaking the legumes in water at room temperature for at least 0.5 hour;
c) filtering the legumes;
d) repeating steps (b) and (c) above up to 4 times;
e) soaking the legumes in fresh water for 24 hours at about 4° C.;
f) boiling the legumes in water for about 30 minutes to about 120 minutes, while removing the foam produced thereby;
g) mashing or grinding the boiled legume fruits, optionally in the boil-water;
h) adding to the mash/grind a desired mixture of spices, herbs, Tehina, olive oil, etc.;
i) if not previously present, optionally, adding the cooled boil-water from step (f) or their concentrate to the mix;
j) placing the mix in desired baking templates or spreading it on a baking tray;
k) baking the mix at about 100° C. to about 150° C. for about 60 minutes to about 180 minutes;
l) optionally, spraying the baked snacks with vegetable oil; and
m) packing the snacks for storage.

Notably, when using frozen or canned legume, some or all of the soaking steps are not necessary. In addition, some legumes may not need prolong soaking or any soaking, e.g. red lentil.

According to specific embodiment of the invention, the legume in the above method is selected from black beans, black-eyed peas, small chickpeas, fava beans, mash, broad beans, lima beans, navy beans, peas, pinto beans, soy beans, white beans, hummus, lentils, and red kidney beans.

The present invention also relates to legume snacks produced by the method of the invention. Optionally, said snack is gluten-free. In a specific embodiment, the legume snack of the invention is made essentially entirely from legume, has essentially no preservatives and has a shelf life of at least about 12 months.

According to one embodiment, the legume snack of the invention is prepared without using artificial supplements, such as cooking enhancers, flavor and aroma additives, stabilizers, binders, etc. In another embodiment, the legume snack of the invention is also prepared without adding thereto any vitamins, minerals, etc.

In another embodiment, the legume snack of the invention has no undesired side-effects associated with legume consumption, wherein said undesired side-effects are, e.g., gases and stomach ache.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### DETAILED DESCRIPTION OF THE INVENTION

Legumes comprise protease inhibitors, which causes low absorption rate, stomach aches, and gases. Another reason for these side-effects is how the starch is stored in the legume. Gases are caused also due to oligosaccharides within the legume, which are fermented in the intestine. In addition, natural legumes are not easily digest, probably due to their high starch content, which remains inside the legume cells even after soaking it in water. Legumes are also extremely hard and are not suitable for consumption without preliminary treatment. Accordingly, there is a need for easily consumed legume-based foods, which are healthy and tasty, and are easy and cheap to produce, and for a method for their production.

The present invention provides such a cheap and easy method for producing legume snacks at any desired shape and size. In one aspect, the method of the invention uses either one type of legume, or can use two or even more legume types for preparing one snack. According to another embodiment of the invention, the legume snack is prepared without adding thereto any preservatives, additives or binders. The end result of the method of the invention is a healthy and nutritious legume snack.

The present invention is the first to find the presently claimed method of producing legume snacks. Said method combines known and new techniques, and includes prolong soaking of the legume while changing the soaking water, which has been found to dramatically improve the bioavailability of the legume, render it easy to work with, and reduces undesired side-effects of legume consumptions (e.g., gases and stomach ache). Furthermore, boiling the legumes and grinding or mashing them makes them even easier to work with and mold them into a desired shape and size, and adds to their bioavailability. Said grinding or mashing further increases starch release from the legume which helps in the production of a snack with a unified texture, which does not crumble. In addition, when grinded or mashed, it is easier to add natural flavorant(s) or other natural additions to improve the snack's taste and/or nutrition and health value. This invention is the first to combine all the above features in a single, easy and chip method to produce a legume snack.

Notably, one reason for the reduced bioavailability of legumes is their high starch content. Accordingly, the natural removal and release of starch from the treated legume according to the method of the invention, without the use of synthetic additives, improves their bioavailability and reduces any side-effects associated with their consumption.

The present invention has also surprisingly found that in the method of the invention for producing a legume snack, the removal of the foam formed during the boiling of the legume, markedly reduces undesired side-effects of legume consumptions, as well as improves the legume's bioavailability.

It is common practice to add sodium bicarbonate to food stuff, and especially to legume based foods in order to (i) add flavor, (ii) enhance softening of legume and reduce the time required for softening, and (iii) reduce digestive problems associated therewith. However, sodium bicarbonate adds a distinctive taste, and reduces the dietary benefits of the legume, e.g. by destroying vitamins, etc.

Accordingly, an embodiment of the invention is to prepare legume-based foods, such as snacks, without using artificial additives, preservatives, colorants, taste improvers, binders, process-enhancers and stabilizers. In a specific embodiment, the legume snack of the invention is made essentially entirely of legume.

In another embodiment, the method of the invention includes the addition of natural spices and flavorants to the legume snacks, such as, but not limited to, salt, garlic, onion, lemon, tomato, cumin (also known to reduce gases), turmeric, pepper (black or white), hot-pepper, flax, mustard, hall, sesame seeds, fennel, coriander, nigella, cinnamon, and caraway. Accordingly, in one embodiment of the invention, the legume snack produced by the method of the invention includes the above mentioned natural spices and flavorants, and/or additional spices and flavorants.

In another embodiment of the invention, the legume-based foods further contain seeds such as sunflower seeds, pumpkin seeds, etc., different walnuts, oily material, such as olive oil, Tahini, etc., herbs, such as parsley, coriander, dill, rosemary, hyssop, basil, ginger, thyme, etc. Optionally, the legume-based foods of the invention may further contain sweeteners, either natural or artificial. In addition, the legume-based foods of the invention may also contain nuts, seeds etc. A skilled artisan would realize that the legume snacks of the invention may include any supplement or additive, and the invention should not be limited by the listed additives and supplements.

In a specific embodiment, the legume snacks of the invention are gluten-free, as it is made essentially entirely from legume. Alternatively, the legume snacks of the invention may be prepared so that they include flour, such as wheat, all-bran, spelt, rye, Quaker, or any other flour including legume flour(s), or any combination thereof. In a specific embodiment, the legume snacks of the invention are basically made only of legumes, and have no artificial additives. The legume snacks of the invention may optionally further contain spices and herbs, olive oil, and rice, preferably whole rice.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. For example, the legume snacks of the invention may also comprise additional ingredients, such as flavorants, vitamins, and any other food-stuff used in the field.

According to one embodiment, the method of the invention uses fresh and/or dried legumes for preparing the legume snacks. According to another embodiment, the method of the invention uses preserved legumes (e.g. canned, dried, frozen, etc.) for preparing the legume snacks of the invention. According to yet another embodiment, the method of the invention uses a legume mash or legume flour for preparing the legume snacks of the invention.

In one aspect, the process of the invention hardly damages the ingredients of the legume. For instance, the method of the invention does not involve frying, no harmful additives are used, and the boiling and baking steps are all done under minimum-damaging conditions. Such minimum-damaging conditions include, but are not limited to, backing at a temperatures of up to 150° C., and baking for a short period of time, such as up to 2-3 hours.

Notably, the baking period can be modified based upon the moisture of the mix, the amount of water (or other liquids) that was added thereto, and according to the conditions of the baking and drying themselves (for example, when vacuum baking the time is markedly reduced compared to regular baking).

As used in the present invention, the term “boil” or “boiling” refers to any boiling technique, including, but not limited to, pressure boiling, steam boil, etc.

The term “drying” refers herein to any drying method, such as turbo drying, heat drying, vacuum drying, etc. and any combination thereof.

The present invention is directed towards satisfying the need that exists in the field for natural and healthy legume foods. Moreover, the present invention prepares a legume snack with lower costs compared to traditional methods of producing similar snacks. The method of the invention also provides a legume snack with a surprisingly long product shelf-life, of more than 12 months, even without the use of any preservatives or vacuum packing. The method of the invention can use either fresh legumes, or preserved legumes, e.g. frozen or canned.

In another embodiment, the legume-based product prepared according to the method of the invention can be used in many diverse ways, such as a snack, a meal additive, a soup additive, a salad addition, as a full meal, etc.

In one aspect there is provided a method for making a legume snack, said method comprises the steps of:
a) washing the legumes to remove dirt, stones and bad legumes;
b) soaking the legumes in water at room temperature for at least 0.5 hour;
c) filtering the legumes;
d) repeating steps (b) and (c) above up to 4 times;
e) soaking the legumes in fresh water for 24 hours at about 4° C.;
f) boiling the legumes in water for about 30 minutes to about 120 minutes, while removing the foam produced thereby;
g) mashing or grinding the boiled legume fruits, optionally in the boil-water;
h) adding to the mash/grind a desired mixture of spices, herbs, Tehina, olive oil, etc.;
i) if not previously present, optionally, adding the cooled boil-water from step (f) or their concentrate to the mix;
j) placing the mix in desired baking templates or spreading it on a baking tray;
k) optionally, spreading the cooking water on the spread mix;
l) baking the mix at about 100° C. to about 150° C. for about 90 minutes to about 120 minutes;
m) optionally, spraying the baked snacks with vegetable oil; and
n) packing the snacks for storage.

In another aspect there is provided legume snacks made by the method of the invention as described above.

These as well as additional features and advantages of the present invention will become apparent in the following examples.

It is to be noted that, throughout the description and claims of this specification, the word “comprise” and variations thereof, such as “comprising” and “comprises”, is not intended to exclude other variants or additional components, integers or steps.

Modifications and improvements to the invention will be readily apparent to those skilled in the art. Such modifications and improvements are intended to be within the scope of this invention.

Any reference to or discussion of any document, act or item of knowledge in this specification is included solely for the purpose of providing a context for the present invention. It is not suggested or represented that any of these matters or any combination thereof formed at the priority date part of the common general knowledge, or was known to be relevant to an attempt to solve any problem with which this specification is concerned.

The following examples further illustrate the invention, and should not be construed as in any way limiting its scope.

It is noted that “legume” as used herein, includes all types and sub-types of legume, including, but not limited to: alfalfa, clover, peas [e.g. black beans, black-eyed peas and chickpeas], beans [e.g. lima, soy and red kidney], lentils and lupins.

The following examples are set forth to further illustrate the method and legume snacks of the invention. The below examples, however, should not be construed as limiting the present invention in any manner.

### EXAMPLES

### Example 1

### General Method for Preparing a Legume Snack

1) washing legumes to remove dirt, stones and bad fruits;
   This step makes sure we use only good fruits, and prevents contamination of the final product.
2) soaking the legumes in water at room temperature for at least 0.5 hour;
3) filtering the legume fruits;
4) repeating steps (2) and (3) above 1-4 more times;
   Repeating the above steps improves the final softening of the legume fruits, and the removal of undesired ingredients.
5) soaking the legumes in fresh water for 24 hours at about 4° C.;
   This step is performed at 4° C. in order to avoid contamination and fermentation of the legume fruits, which occurs at room temperature during long soaking times. Accordingly, the above steps lead to the bloating and softening of the legume while removing therefrom harmful ingredients, and thus helps to reduce legume-associated consumption problems, such as gases and stomach ache.
6) boiling the legumes in water for about 30 minutes to about 90-120 minutes, while removing the foam produced thereby;
   This step soften the legumes to such a degree that enables mashing them. The duration of the boiling varies depending on the type of legume used, the ratio of legume to water, the condition of the legumes themselves (fresh, frozen, dried, etc.), etc. In addition, the foam contains different ingredients which are responsible for some of the legume-associated side-effects, and its removal reduces said side-effects when the final products is consumed.
7) mashing or grinding the boiled legume fruits;
   A mash or grind is easier to work with, enables to add different ingredients thereto, and facilitates shaping the final product as pleased. This step can be performed with or without the boil-water or concentrate.
8) adding to the mash/grind a desired mixture of spices, herbs, etc.;
   This step enables to produce a snack in any desired flavor and color, and also to improve its dietary and health properties.
9) if not already present, optionally, adding the boiling water from step (6) and/or their concentrate to the mix;
   This step can improve the stability of the final product prevent it from crumbling, and shorten the preparation time.
10) optionally, adding Tehina and vegetable oil, preferably olive oil, to the mash/grind, and further mixing;
   This step further improve the product's flavor and dietary and health properties, and also makes the snack more crispy and moist-like.
11) placing the mix in desired baking templates or spreading it on a baking tray;
12) optionally, spreading the cooking water on the spread mix;
13) baking the mix at about 100° C. to about 150° C. for about 90 minutes to about 180 minutes;
   These baking times and temperatures make sure that the ingredients in the product are not destroyed and lose their beneficial dietary and health properties. They are dependent on the temperature and conditions of baking, as well as on the different properties of the snack itself, such as its width and shape, its water content, etc. During the baking, the snacks can be turned over for even baking and/or shorten the baking time.
14)optionally, spraying the baked snacks with vegetable oil, preferably olive oil; and
15)packing the snacks for storage.
   Packing can be done either in vacuum-sealed packs, or any other acceptable form, which is suitable for long term storage.

The various conditions in the above steps may vary depending on the type and sub-type of the legume, and on its condition (fresh, frozen, dried, canned, etc.). Notably, when using frozen or canned legume, some or all of the soaking steps can be omitted.

### Example 2

### Preparation of a Chickpea Snack

a) 200g of small chickpea fruits are washed to remove dirt and stones;
b) the fruits are soaked in water for at least 1 hour, and the water is replaced 2-3 times;
c) the fruits are soaked in water for 24 hours at about 4° C.;
d) the soaked fruits are boiled for 90-120 minutes, after which the water are saved and cooled;
e) the boiled fruits are grinded or mashed together with the boil-water and a mixture of desired spices, e.g.: (i) fine chopped fresh parsley and coriander, (ii) garlic, (iii) salt; (iv) grinned coriander fruits, (v) cumin, (vi) red spicy pepper, and (vii) cardamom;
f) Tehina and/or olive oil are added to the mixture;
g) the mix is placed on a baking pan, and baked at about 100-150° C. for 90 to 180 minutes; and
h) after cooling, the dried snacks are packed.

### Example 3

### Preparation of a Common Bean Snack

The snack is prepared according to the particulars of Example 2, with the exception that common bean was used instead of small chickpea.

### Example 4

### Preparation of a Lentils Snack

The snack is prepared according to the particulars of Example 2, with the following exceptions:
lentils was used instead of small chickpea;
the fruits are soaked in water for 0.5 hour, and the water is replaced only once; and
cooked rice was added to the boiled lentils before grinding.

### Example 5

### Preparation of a Chickpea Snack

The snack is prepared according to the particulars of Example 2 above, with the exception that the cooled boiling-water was added to the mashed fruits.

### Example 6

### Preparation of a Chickpea Snack

The snack is prepared according to the particulars of Example 4 above, with the exception that in addition to the cooled boiling-water, flour was added to the mashed fruits. The following flours were used: whole wheat flour, rye flour, and spelt flour.

### Example 7

### Preparation of a Chickpea Snack

The snack is prepared according to the particulars of Examples 2, 4 or 5 above, with the exception that the final baked product was turned over and baked for another 30 minutes.

### Example 8

### Preparation of a Chickpea Snack

The snack is prepared according to the particulars of Example 2 above, with the exception that the boiling-water was not added to the grind.

### Example 9

Spices and Herbs that can be Used in the Above Methods:

salt, garlic, onion, lemon, tomato, cumin, turmeric, paprika, black pepper, white pepper, hot-pepper, flax, mustard, hall, sesame seeds, fennel, coriander, basil, thyme, Zaatar, Shamir, parsley, nigella, cinnamon, ginger and caraway. Notably, other spices and herbs can be used dependent on the population and age.

### Example 10

### Subjective Taste Comparison Between Different Legume Snacks

The following legume snacks were prepared according to the above Examples (Table 1) and where submitted to blind test individuals. The results of the taste test are summarized in the following Table 2.

TABLE 1

| # | Legume content |
|---|---|
| 1 | Lentils |
| 2 | Hummus |
| 3 | Mash |
| 4 | White beans |
| 5 | Hummus + whole wheat |
| 6 | Mash + White beans |
| 7 | Hummus + Mash |
| 8 | Hummus + Mash + White beans |
| 9 | Hummus + whole wheat + Linen |
| 10 | Soy beans |
| 11 | Frozen peas |

TABLE 2

| | Taste score* | | |
|---|---|---|---|
| Legume content | 1 | 2 | 3 |
| Hummus (#2) | 3 | 6 | 41 |
| Mash (#3) | 0 | 2 | 14 |

*1 means bad taste and 3 means very tasty.

As evident from Table 2, the legume snack of the invention has a surprisingly superior taste compared to snacks prepared according to the commonly used methods.

### Example 11

### Gases and Stomach Aches Due to Legume Snacks Consumption

Test individuals fed with the legume snacks of Example 10 were asked to rank the degree of resulting gases and stomach ache during the next 24 hours after consumption. The results of the test are summarized in the following Table 3:

TABLE 3

| | Gas* | | | | Stomach ache* | | | |
|---|---|---|---|---|---|---|---|---|
| Legume content | 1 | 2 | 3 | 4 | 1 | 2 | 3 | 4 |
| Hummus | 50 | 0 | 0 | 0 | 50 | 0 | 0 | 0 |
| Mash | 16 | 0 | 0 | 0 | 16 | 0 | 0 | 0 |

*1 means no effect and 4 means very disturbing and painful.

As it can be seen from Table 3, the legume snacks of the invention surprisingly have no side effects compared to known legume-containing snacks.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the present invention has been described above in connection with the certain illustrative embodiments, it is to be understood that other similar embodiments may be used or modifications and additions may be made to the described embodiments for performing the same function of the present invention without deviating therefrom. Furthermore, all embodiments disclosed are not necessarily in the alternative, as various embodiments of the invention may be combined to provide the desired characteristics. Variations can be made by one having ordinary skill in the art without departing from the spirit and scope of the invention. Therefore, the present invention should not be limited to any single illustrative embodiment, but rather construed in breadth and scope in accordance with the recitation of the attached claims.

1-13. (canceled)

14. Method of producing a legume snack, comprising the steps of:
a) soaking legumes;
b) boiling the legumes;
c) mashing or grinding the boiled legumes;
d) adding to the mash/grind a mixture comprising: spices, herbs, olive oil, or any combination thereof;
e) placing the mix in a baking template-or spreading it on a baking tray; and
f) obtaining a baked snack by baking or drying the mix; thereby producing a legume snack.

15. The method of claim 14, wherein said legumes comprise: black beans, black-eyed peas, small chickpeas, fava beans, mash beans, broad beans, lima beans, navy beans, peas, white beans, pinto beans, soy beans, hummus, lentils, red kidney beans, or any combination thereof.

16. The method of claim 14, wherein the legumes are fresh.

17. The method of claim 14, wherein the legumes are frozen, dried, or canned.

18. The method of claim 14, wherein said vegetable oil is olive oil.

19. A legume snack produced by the method of claim 1.

20. The legume snack of claim 19, which is gluten-free.

21. The legume snack of claim 19, made essentially from legume.

22. The legume snack of claim 19, devoid of preservatives.

23. The legume snack of claim 19, devoid of cooking enhancers, flavor, aroma additives, stabilizers, binders, or any combination thereof.

24. The legume snack of claim 19, which is crispy.

25. The legume snack of claim 19, free of side effects comprising gases and stomach ache.

26. The method of claim 14, wherein said step d further comprises adding the cooled boil-water from step (f) or their concentrate to the mix.

27. The method of claim 14, further comprising the step of spraying the baked snacks with a vegetable oil or an olive oil.

28. The method of claim 14, further comprising the step of packing the snacks for storage.
